(19) United States
(12) Patent Application Publication
(10) Pub. No.: US 2025/0188384 A1
(43) Pub. Date: Jun. 12, 2025

(54) FAT COMPOSITION AND RELATIONSHIP WITH FREE FATTY ACID DISTRIBUTION

(71) Applicant: Savor Foods Limited, San Jose, CA (US)

(72) Inventors: Sydney Schreppler, San Jose, CA (US); Aleesha Slattengren, San Jose, CA (US); Ailin Zhang, San Jose, CA (US); Kathleen Alexander, San Jose, CA (US); Nikifar Lazouski, San Jose, CA (US)

(73) Assignee: Savor Foods Limited, San Jose, CA (US)

(21) Appl. No.: 18/974,401

(22) Filed: Dec. 9, 2024

Related U.S. Application Data
(60) Provisional application No. 63/607,976, filed on Dec. 8, 2023.

(51) Int. Cl. C11C 3/02; A23D 9/02

(52) U.S. Cl. CPC C11C 3/02; A23D 9/02

(57) ABSTRACT

A fat formulation can include a first set of glycerides that can include glycerides with fatty acids selected from a first distribution of linear saturated fatty acids and a second set of glycerides with fatty acids selected from a second distribution of linear saturated fatty acids, where the first and second distribution of linear saturated fatty acids are each subsets from a shared initial distribution of fatty acids.

### CROSS-REFERENCE TO RELATED APPLICATIONS

This application claims the benefit of U.S. Provisional Application No. 63/607,976 filed 8 Dec. 2023, which is incorporated in its entirety by this reference.

### TECHNICAL FIELD

This invention relates generally to the fat composition field, and more specifically to a new and useful formulation and method of manufacture in the fat composition field.

### BRIEF DESCRIPTION OF THE FIGURES

FIG. 1 is a schematic representation of an exemplary embodiment of the fat composition.

FIGS. 2A and 2B are bar chart representations of exemplary full free fatty acid distributions (e.g., the resulting distribution of fatty acids from synthesis).

FIGS. 3A-3E are bar chart representations of exemplary fat compositions that include a primary formulation and secondary formulation. FIGS. 3A and 3E are for exemplary formulations derived from the exemplary distribution shown in FIG. 2A. FIGS. 3B, 3C, and 3D are for exemplary formulations derived from the exemplary distribution shown in FIG. 2B (where FIG. 3C further includes additional long chain fatty acids not present in the distribution of FIG. 2B and FIG. 3D excludes short chain fatty acids present in the distribution of FIG. 2B).

FIG. 4 is a schematic representation of an example of a melting behaviour for a primary formulation (e.g., as shown for instance in FIG. 3A), secondary formulation (e.g., as shown for instance in FIG. 3A), full distribution (e.g., as shown for instance in FIG. 2A), and mixture of the primary formulation and secondary formulation.

FIG. 5 is a schematic representation of an example of an as-synthesized fatty acid carbon distribution, a first distribution of fatty acids included in a first set of glycerides, and a second distribution of fatty acids included in a second set of glycerides (e.g., where the second distribution is the inverse of the first distribution of fatty acids relative to the as-synthesized distribution of fatty acids).

FIGS. 6A and 6B are a tabular representation of examples of inverse fat formulations. In this table, for each entry, numbers on the left hand side of the ‘/’ are in the first distribution while numbers on the right hand side of the ‘/’ are in the second distribution.

FIG. 7 is a tabular representation of exemplary full fatty acid distributions.

### DETAILED DESCRIPTION

The following description of the embodiments of the invention is not intended to limit the invention to these embodiments, but rather to enable any person skilled in the art to make and use this invention.

### 1. Overview

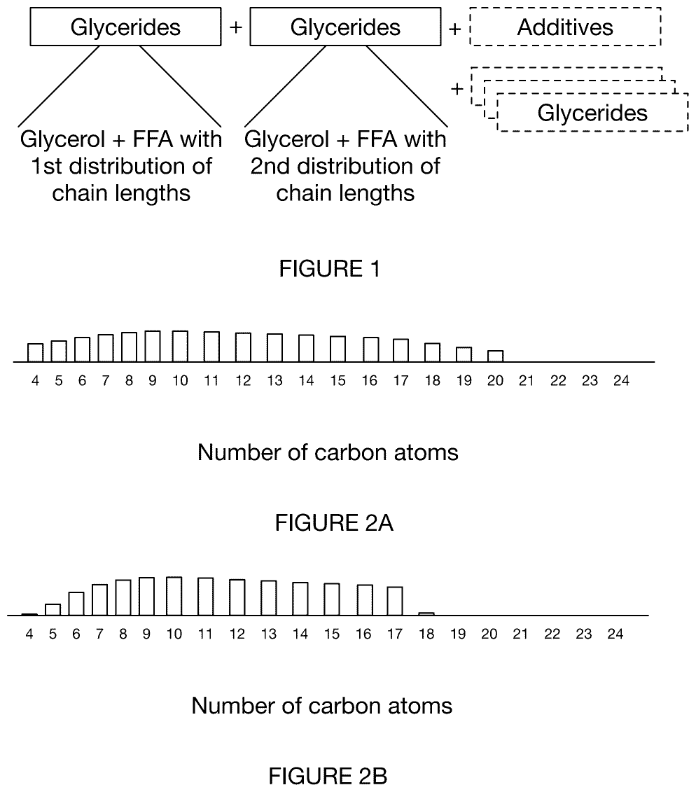

As shown for example in FIG. 1, a formulation can include a first set of glycerides, a second set of glycerides, and optionally one or more additives. The first and second set of glycerides are preferably separate and distinct from one another. Note that in general the formulation is not limited to only a first and second set of triglycerides (e.g., can include a third, fourth, fifth, etc. set of triglycerides where each set of triglycerides preferably includes triglycerides formed by esterifying a different distribution of fatty acids). However, in some variants, the formulation can consist of, consist essentially of, be composed of, be composed essentially of only two sets of triglycerides. As an illustrative example, the first set of glycerides can include glycerol that is esterified with free fatty acids selected from a first distribution of free fatty acids and the second set of glycerides can include glycerol that is esterified with free fatty acids selected from a second distribution of free fatty acids. However, the first and second set of glycerides can be substantially the same.

The formulation can be, for instance, an agriculture-free (e.g., does not include materials derived from agricultural products, includes materials derived from chemical processing, etc.), an agriculture light (e.g., less than about 10% by mass, by volume, by stoichiometry, etc. of the composition can be derived from agricultural products), animal-free (e.g., does not include materials derived from animal products or byproducts, does not include fatty acids derived from animal products or byproducts, etc.), animal light (e.g., includes less than about 10% by mass, by volume, by stoichiometry, etc. materials derived from animal products or byproducts; includes less than about 10% by mass, by volume, by stoichiometry, etc. fatty acids derived from animal products or byproducts; etc.), plant-free (e.g., does not include materials derived from plant products or byproducts, does not include fatty acids derived from plant products or byproducts, etc.), plant-light (e.g., includes less than about 10% by mass, by volume, by stoichiometry, etc. materials derived from plant products or byproducts; includes less than about 10% by mass, by volume, by stoichiometry, etc. fatty acids derived from plant products or byproducts; etc.), eco-conscious (e.g., includes materials that are sustainable, low carbon foot print such as less than about 10 kg CO₂ emitted per kg of products produced, low ecological footprint, local materials or derived from local materials or foodstuffs, etc.), and/or any suitable formulation.

The formulation can be used, for example, as a fat in food products (e.g., as a nutritional supplement such as for baby formula, for nutritional bars, for drinks, etc.; a performance additive such as for stabilizing nut butters, seed butters, etc.; a fat source in plant based products such as a fat included in a plant-based yogurt, plant-based cheese, etc.; etc.), a baking or cooking oil (e.g., frying oil such as for French fries, meat products, vegetables, party items, etc.; fat for baked goods, confections, chocolate, ice cream, etc.; cooking spray or otherwise prepare a nonstick or low-stick cooking or baking surface; etc.), sauces (e.g., dips, dressings, condiments, etc.), a soap, a lubricant, creamer (e.g., coffee creamer), a surfactant, detergent, emulsifier, texturizing agent, wetting agent, anti-foaming agent, stabilizing agent, emollient, metal working fluid, water treatment, varnish or other surface treatment, in personal care or cosmetic products (e.g., in lip balm, lotions, make-up, moisturizers, perfumes, lipstick, nail polish, shampoo, colorant, deodorants, essential oil, massage oil, soap, etc.), aromatherapy, and/or can be used for any suitable purpose. For example, the formulation can be a food grade (e.g., generally recognized as safe (GRAS) for consumption) fat replacement for one or more of the following fats: lard (e.g., leaf lard), tallow (e.g., beef tallow, mutton tallow, lamb tallow, bison tallow, etc.), tail fat, poultry fat (e.g., duck fat, goose fat, chicken fat, turkey fat, foie gras, etc.), schmaltz (e.g., clarified chicken fat, clarified goose fat, clarified duck fat, etc.), dripping (e.g., beef dripping, pork dripping, etc.), suet, fish oil (e.g., sardine oil, herring oil, anchovy oil, salmon oil, trout oil, tuna oil, swordfish oil, mackerel oil, cod liver oil, shark liver oil, etc.), blubber (e.g., whale fat, seal fat, etc.), Bovidae fat (e.g., bison fat, water buffalo fat, cattle fat, yak fat), Camelidae fat (e.g., dromedary fat, llama fat, etc.), Capra fat (e.g., goat fat, goat milkfat, etc.), Cervidae fat (e.g., elk fat, fallow deer fat, moose fat, red deer fat, reindeer fat, white-tailed deer fat, etc.), Equidae fat (e.g., donkey fat, horse fat, etc.), Lagomorph fat (e.g., rabbit fat), Macropodidae fat (e.g., kangaroo fat), Ovis fat (e.g., sheep fat, lamb fat, mutton fat, sheep milkfat, etc.), Suidae fat (e.g., pig fat, boar fat, etc.), amphibian fat (e.g., frog fat, salamander fat, etc.), bird fat (e.g., chicken fat, duck fat, goose fat, turkey fat, quail fat, pigeon fat, guineafowl fat, ostrich fat, emu fat, peacock fat, egg fat, etc.), crustacean fat (e.g., crayfish fat, crab fat, lobster fat, shrimp fat, prawn fat, etc.), mollusk fat (e.g., oyster fat, mussel fat snail fat, abalone fat, etc.), reptile fat (e.g., alligator fat, crocodile fat, turtle fat, etc.), game fat (e.g., bushmeat fat, antelope fat, porcupine fat, cane rat fat, elephant fat, snake fat, rattle snake fat, caribou fat, hare fat, opossum fat, bear fat, deer fat, etc.), simian fat, canine fat, feline fat, shortening, milkfat or butterfat (e.g., cow milk, goat milk, sheep milk, yak milk, buffalo milk, etc. such as for milk, cream, hard cheese, soft cheese, spreadable cheese, melting cheese, processed cheese, vegan cheese, etc.), ghee (e.g., clarified butter), intramuscular fat or marbling replacement (e.g., for beef, for pork, for buffalo, for mutton, for sheep, for veal, for goat, for yak, for poultry, etc.), intermuscular fat replacement (e.g., for beef, for pork, for buffalo, for mutton, for sheep, for veal, for goat, for yak, for poultry, etc.), subcutaneous fat replacement (e.g., for beef, for pork, for buffalo, for mutton, for sheep, for veal, for goat, for yak, for poultry, etc.), vegetable oil (e.g., cocoa butter, shea butter, coconut oil, coconut butter, coconut milk, coconut cream, palm oil, hydrogenated palm oil, palm kernel oil, mango butter, Borneo tallow, seed oils, nut oils, coffee oil, tea tree oil, vegetable shortening, etc.), and/or for any suitable fat replacement (e.g., a vegan fat replacement, a vegetarian fat replacement, a kosher fat replacement, a halal fat replacement, a vegan animal fat mimic, a vegetarian animal fat mimic, a kosher animal fat mimic such as a substitute for pork fat that is kosher, a halal animal fat mimic such as a substitute for pork fat that is halal, etc.).

### 2. Technical Advantages

Variants of the technology can confer one or more advantages over conventional technologies.

First, variants of the technology can enable lower carbon footprint and/or carbon impact fats to be used. For instance, by using lipids (e.g., free fatty acids, esterified fatty acids, glycerolipids, etc.) derived from low or negative carbon footprint processes (e.g., processes that capture, trap, etc. carbon and convert the carbon to fatty acids, fatty esters, etc.), a low carbon footprint fat can be produced. In some aspects of the invention, a carbon footprint to produce a fat or formulation can be less than a carbon footprint for an identical or analogous fat derived from agricultural processes. In some variations of the invention, by using odd chain length fatty acids (in addition to or alternatively from) even chain length fatty acids can help lower a carbon footprint of the formulation (e.g., by reducing a total number of processing steps to prepare the fatty acids, by reducing an amount of waste, etc.).

Second, variants of the technology can enable better utilization of (e.g., reducing the amount of waste, improving the yield of valuable fatty acids, etc.) fatty acids derived from a chemical process. For example, instead of using a formulation that requires a portion of the as-synthesized fatty acids to be discarded, the same formulation (e.g., with beneficial properties) can be mixed with a second set of lipids (e.g., glycerides) derived from fatty acids remaining from the distribution of as-synthesized fatty acids (e.g., an inverse distribution of fatty acids from that first distribution relative to the as-synthesized distribution, fatty acids remaining in the as-synthesized distribution after removing the first distribution, etc.). In some examples, the first distribution alone can result in about 30-70% utilization (e.g., by mass) of the as-synthesized distribution while the first and second distribution can result in 60-90% utilization of the as-synthesized distribution of fatty acids (where the percent utilization is exclusive greater when more distributions are used). Note, the additional distributions (e.g., second distribution) need not include the entirety of the inverse distribution, but can include any suitable subset of the as-synthesized distribution after the first distribution of fatty acids has been separated.

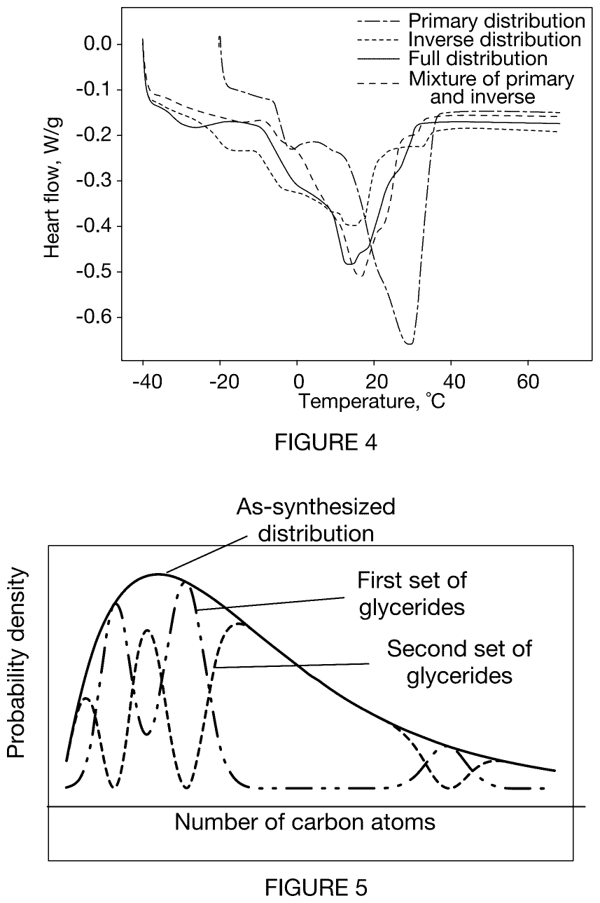

Third, variants of the technology can enable improved organoleptic behaviour of the formulation (e.g., to better mimic a target fat). For example, a first set of glycerides can use a distribution of fatty acids chosen to mimic a thermal behaviour (e.g., melting point, melting profile, etc.) of the target fat and the second set of glycerides can soften and/or harden the formulation (without substantially changing the thermal behaviour of the first set of glycerides as shown for example in FIG. 4). Without being confined to one theory, the second set of glycerides are hypothesized to interrupt crystallization of the first set of glycerides to (typically) soften the resulting formulation. However, the mixture may modify any suitable organoleptic behaviour of the formulation. Relatedly, variants of the technology can additionally or alternatively modify other properties of the formulation such as occlusiveness (e.g., barrier to moisture loss), dispersiveness (e.g., ability of the formulation to dissolve one or more additive), penetration (e.g., ability of the formulation or components thereof to be absorbed by, speed of absorption by, penetration into, etc. a substrate such as skin), melting point, and/or other similar properties.

Fourth, variants of the technology can produce performant fat formulations that accurately, convincingly, and/or otherwise mimic properties of a fat to be replicated. For example, the fat formulations can have a similar mouthfeel, texture, melting point, smoke point, taste, hardness, brittleness, spreadability, graininess, oiliness, stickiness, temperature-dependent viscosity, and/or other suitable property(s) compared to the fat to be replicated. In some variations, using a gapped set of fatty acids to form at least one set of glycerides (e.g., using at least one set of glycerides that includes a combination of fatty acids where at least one intermediate carbon chain length is absent or nearly absent such as at most a 5% prevalence relative to target carbon chain lengths, etc.) can enable and/or be beneficial for achieving complex formulation behaviour (e.g., more able to mimic a behaviour of a fat to be replicated).

However, further advantages can be provided by the system and method disclosed herein.

### 3. Formulation

As shown for example in FIG. 1, a formulation can include a first set of glycerides, a second set of glycerides, and optionally one or more additives. The formulation can function as a functional fat analogue, fat mimic, a fat with custom properties, and/or can be used in any manner. While in some embodiments, only a first and second set of glycerides are used, the formulation is not limited as such. For instance, embodiments of the formulation could include third, fourth, and/or greater number of sets of glycerides (e.g., with properties similar to or distinct from properties of sets of glycerides as described below) and/or other lipids (e.g., cholesterol(s), phospholipid(s), sterol(s), vitamin(s), fatty acyl(s), sphingolipid(s), prenol(s), saccharolipid(s), polyketide(s), etc. in addition to or as an alternative to at least one set of glycerides).

The different sets of glycerides are preferably distinct from one another. Examples of differences between the sets of glycerides can include one or more of: hydroxyl number (e.g., relative ratio of triglycerides to diglycerides and monoglycerides within each set), average molecular weight (or molecular weight distribution of individual glycerides thereof), free fatty acid distribution (e.g., which free fatty acids are used to form the glycerol esters), esterification of the free fatty acids in the glycerides (e.g., stochasticity of esterification, designed esterification, etc.), thermodynamic behaviour (e.g., melting point, melting profile, smoke point, enthalpy of melting, crystallization point, crystallization profile, crystallization phase, etc.), rheological behaviour (e.g., slip point, viscosity, consistency, flow, etc.), organoleptic behaviour (e.g., taste, smell, feel, sound, appearance, color, mouth feel, etc.), optical properties (e.g., transparency, translucency, light scattering, color, refractive index, transmittance, reflectance, turbidity, birefringence, etc.), phase separation behaviour (e.g., phase stability, ability to phase separate such as to form layers, etc.), emulsifying properties (e.g., surface tension, foaming, coalescence, avalanche, coarsening, foam drainage, dewetting, bursting, flocculation, creaming, sedimentation, Ostwald ripening, etc.), mechanical properties (e.g., softness or hardness, elastic modulus, Poisson's ratio, yield stress, spreadability, etc.), and/or any suitable properties can differ.

As an illustrative example, a first set of glycerides can include glycerol that is esterified with free fatty acids selected from a first distribution of free fatty acids (e.g., where the free fatty acids are interesterified forming a substantially stochastic distribution of glycerides containing a mixture of free fatty acids together) and the second set of glycerides can include glycerol that is esterified with free fatty acids selected from a second distribution of free fatty acids (e.g., where the free fatty acids are interesterified forming a substantially stochastic distribution of glycerides containing a mixture of free fatty acids together). In this illustrative example, the first set of glycerides and the second set of glycerides can be mixed together (e.g., the first set of glycerides and the second set of glycerides are each intraesterified but are not substantially esterified together). In some variations of the first illustrative example, one or more additional sets of glycerides can be included in the fat formulation. For instance, a third set of glycerides with predominantly long chain fatty acids (e.g., C18:0, C19:0, C20:0, C21:0, and/or longer chain fatty acids) or short chain fatty acids (e.g., C7:0, C6:0, C5:0, C4:0, and/or shorter chain carboxylic acid) can be included to increase the utilization of the as-received fatty acids, interfere with and/or promote crystallization of the fat formulation, and/or can otherwise be included (e.g., to tune one or more additional properties of the fat formulation).

As a second illustrative example, a fat formulation can include a first glyceride distribution, a second glyceride distribution, and a third glyceride distribution where the first glyceride distribution is associated with a low melting point, the second glyceride distribution is associated with an intermediate melting point, and the third glyceride distribution is associated with a high melting point. In one such variation (e.g., to mimic a milk fat, butter fat, for inclusion in a lacticinia, to mimic a milk fat behaviour in a food product, etc.), the low melting point component can have a melting point between −25 and 10° C., the intermediate melting point can have a melting temperature between 10 and 20° C., and the high melting point component can have a melting point greater than 20° C. (e.g., between 20 and 35° C., between 20 and 40° C., between 25 and 40° C., between 30 and 35° C., greater than 30° C., greater than 50° C., greater than 60° C., etc.). However, other temperature ranges can be realized. In one variation of the second illustrative example, the first glyceride distribution can include a mixture of glycerides with predominantly (but not necessarily exclusively such as ≥50%, ≥60%, ≥75%, ≥80%, etc. by mass) between 15 and 36 carbon atoms, the second glyceride distribution can include a mixture of glycerides with predominantly (but not necessarily exclusively such as ≥50%, ≥60%, ≥75%, ≥80%, etc. by mass) between 37 and 51 carbon atoms, and the third glyceride distribution can include a predominantly (but not necessarily exclusively such as ≥50%, ≥60%, ≥75%, ≥80%, etc. by mass) mixture of glycerides with greater than 51 carbon atoms. In a second variation of the second illustrative example, the first glyceride distribution can include predominantly (but not necessarily exclusively such as ≥50%, ≥60%, ≥75%, ≥80%, etc. by mass) fatty acids with at most 11 carbon atoms, the second glyceride distribution can include predominantly (but not necessarily exclusively such as ≥50%, ≥60%, ≥75%, ≥80%, etc. by mass) fatty acids with between 12 carbon atoms and 16 carbon atoms (inclusive of the end points), and the third glyceride distribution can include predominantly (but not necessarily exclusively, such as ≥50%, ≥60%, ≥75%, ≥80%, etc. by mass) fatty acids with at least 17 carbon atoms. However, other variations can be realized.

The different sets of glycerides preferably form a mixture (e.g., are homogenously mixed together). The behaviour of (e.g., properties of) the formulation can depend on how the mixture is formed (e.g., how the first and second sets of glycerides are mixed), the ratio of different sets of glycerides to one another, distribution of fatty acids associated with each set of glycerides, the initial distribution of fatty acids (e.g. the as-synthesized fatty acid distribution, the as-received fatty acid distributions, etc. used to generate each set of glycerides), whether the distributions used to form the sets of glycerides include one (or more) gaps (and/or other complexities such as bimodal, trimodal, etc.; non-uniform distribution; distributions such as described in U.S. patent application Ser. No. 18/619,539 titled ‘FAT FORMULATIONS’ filed 28 Mar. 2024, U.S. patent application Ser. No. 18/428,575 titled ‘MILKFAT OR BUTTERFAT FORMULATIONS’ filed 31 Jan. 2024, or U.S. patent application Ser. No. 18/818,047 titled ‘LIQUID OR SEMI-SOLID FAT FORMULATIONS’ filed 28 Aug. 2024 each of which is incorporated in its entirety by this reference; etc.), an order of mixing the sets of glycerides, a hydroxyl number of the set of glycerides, and/or other characteristics of the formulation components and/or process of combining them. For instance, high shear blending can result in introduction of air (which can result in a fluffy or less dense formulation than a formulation devoid of air) whereas roll out mixing can result in less air (often resulting in a denser formulation). However, other methods of mixing can be used (e.g., liquid phase mixing such as at a temperature where the sets of glycerides are liquid, solid phase mixing such as at a temperature where the sets of glycerides are solid, solid-liquid mixing such as at a temperature where at least one set of glycerides are liquid and another set is solid, etc. where liquid and/or solid can also include gel-like states such as with solid fat contents between about 1-5%; such as to control an amount of air or other inclusion in the formulation). However, the sets of glycerides can additionally or alternatively be inhomogeneously mixed (e.g., form a phase separated formulation) and/or can otherwise interact (e.g., can undergo re-esterification between the separate sets of glycerides).

The glycerides (e.g., first and second set of glycerides, fatty acids and/or other lipids thereof, etc.) are preferably derived from a chemical process (e.g., oxidation of paraffins, from captured carbon dioxide, from natural gas, from carbon monoxide, from syngas, from coal, from biomass, from a Fischer-Tropsch synthesis, from a Ziegler-method synthesis, artificial fatty acids, etc.), but can additionally or alternatively be cultured (e.g., produced via cells), derived from biological processes (e.g., fatty acids obtained from plants, fungi, microbes, animals, etc.), and/or can otherwise be obtained or derived.

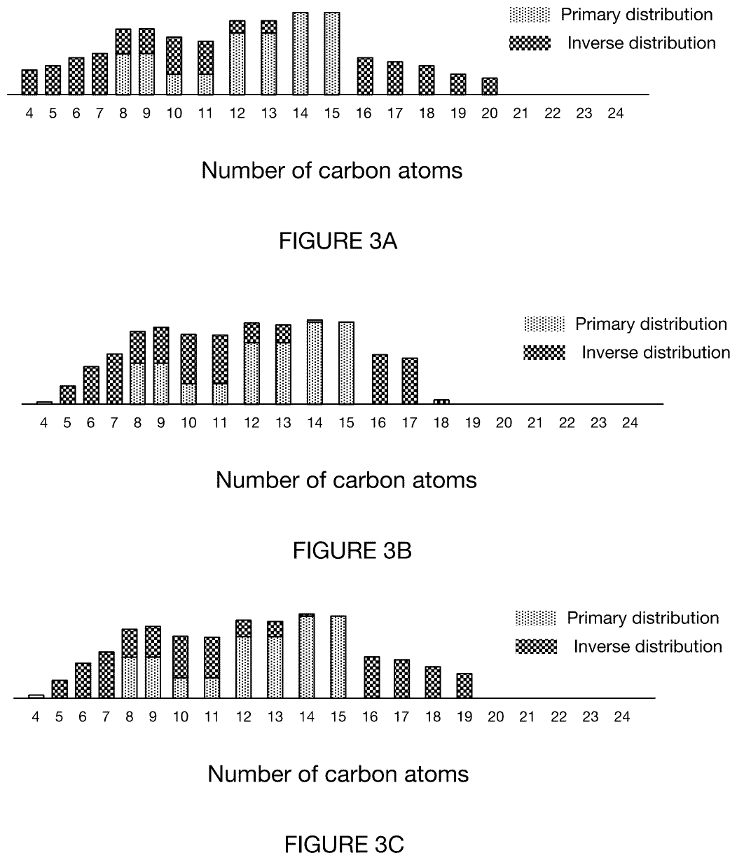

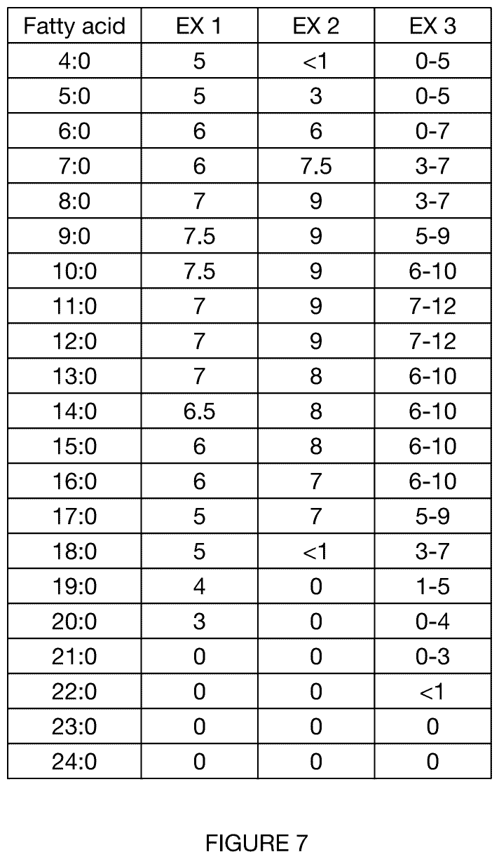

The sets of glycerides (e.g., fatty acids thereof) are typically related to each other. For instance, the sets of glycerides can each be derived from (e.g., subsets of) an initial distribution of fatty acids (sometimes referred to as a full distribution, an as-synthesized distribution, or an as-received distribution). However, one or more sets of glycerides can additionally or alternatively be derived from another distribution (e.g., a truncated initial distribution, a modified initial distribution, separate distributions for different sets of glycerides, etc.). The initial distribution of fatty acids can be as-synthesized fatty acids, purified fatty acids, deodorized fatty acids, and/or can include any suitable fatty acids (e.g., from the fatty acid production method). The initial distribution can depend on the process (e.g., process scale, process temperature, process time, etc.) used to produce the fatty acid distribution; however, typically the same process parameters will result in approximately the same fatty acid distribution. The combination of the sets of glycerides preferably results in at least 50% (e.g., 55%, 60%, 65%, 70%, 75%, 80%, 90%, 100%, values or ranges therebetween, etc.) utilization (e.g., by mass, by volume, by stoichiometry, etc.) of the initial fatty acid distribution (whereas typically a single set of glycerides will only result in at most about 30% utilization of the initial distribution). As shown for example in FIG. 2A, FIG. 2B, or FIG. 7, the initial distribution of fatty acids preferably includes fatty acids with a carbon chain length between about 4 and 22 carbon atoms long. However, the initial distribution can include shorter and/or longer chain fatty acids. The fatty acids are preferably saturated fatty acids (e.g., only saturated fatty acids, less than 5% unsaturated fatty acids, etc.). However, in some variants, one or more of the sets of glycerides can include unsaturated fatty acids (e.g., such to achieve an unsaturated fat composition of up to 30% by mass of the fat composition where exemplary unsaturated fatty acids in the set of glycerides include but are not limited to C18:3, C18:4, C20:5, C22:6, C18:2, C18:3, C20:3, C20:4, C22:4, C16:1, C18:1, C20:1, C22:1, C24:1, etc.). For instance, a fat formulation could include a set of glycerides (e.g., a third set of glycerides) including primarily (e.g., consisting of, consisting essentially of, composed of, composed essentially of, including at least 90% by mass, etc. saturated fatty acids). The fatty acids are preferably linear fatty acids (e.g., only linear fatty acids, less than 5% branched fatty acids, less than 5% cyclic fatty acids, etc.). However, any suitable fatty acids can be included in the initial distribution. The initial distribution can be described by a Benford distribution, Bernoulli distribution, beta-binomial distribution, categorical distribution, hypergeometric distribution, Poisson binomial distribution, Rademacher distribution, soliton distribution, uniform distribution, Zipf distribution, Zipf-Mandelbrot distribution, beta negative binomial distribution, Borel distribution, Conway-Maxwell-Poisson distribution, discrete phase-type distribution, Delaporte distribution, extended negative binomial distribution, Flory-Schulz distribution, Gauss-Kuzmin distribution, geometric distribution, logarithmic distribution, mixed Poisson distribution, negative binomial distribution, Panjer distribution, parabolic fractal distribution, Poisson distribution, Skellam distribution, Yule-Simon distribution, zeta distribution, multimodal distribution, and/or can be described by any suitable distribution. The distribution can depend on (e.g., be controlled based on): feedstock for the fatty acid preparation, preparation parameters (e.g., temperature, time, pressure, reagents, oxidation catalyst, etc.), fractionation, purification, and/or can depend on any suitable variable(s). As a specific example, an initial distribution of fatty acids can be prepared by oxidation of alkanes from a Fischer-Tropsch process (in which the alkanes follow an Anderson-Schulz-Flory distribution) resulting in fatty acids with a peak fatty acid chain length between 8 and 14 carbon atoms long (as shown for example in FIG. 7). In some variants, the resulting fatty acids could follow an Anderson-Schulz-Flory distribution of chain lengths (likely with different parameters compared to the alkanes they are formed from). However, the mass fractions of fatty acids with different chain lengths can follow any suitable distribution. However, other as-synthesized distributions can be used.

The ratio (e.g., mass ratio, volume ratio, stoichiometric ratio, etc.) of the sets of glycerides to one another can be selected to optimize usage of the initial distribution, optimize an impact to the properties of the formulation relative to the target properties (e.g., thermal properties of the formulation relative to the target fat to mimic, mechanical behaviour, spreadability, softness, etc.), optimize for similarity (e.g., similarity of a property, similarity of fatty acid composition, etc.) to a composition of a fat to be mimicked, optimize for a molecular weight (e.g., average molecular weight) of the glycerides of the formulation, and/or can otherwise be selected (e.g., to optimize a combination of effects simultaneously, where each effect can have the same or different weights, where the optimization can be objective such as based on a numerical score or subjective such as based on a trained or untrained tester, etc.). Typically the ratio for two sets of glycerides (in variants that attempt to utilize a majority of the as-synthesized fatty acids while simultaneously achieving target performance) will be between about 10:1 and about 1:10 (e.g., 8:1, 6:1, 4:1, 3:1, 7:3, 2:1, 1:1, 1:2, 3:7, 1:3, 1:4, 1:6, 1:8, values or ranges therein, etc.) for the first set of glycerides to the second set of glycerides (where in these examples the first set of glycerides are generally designed with a target property such as target melting profile, solid fat content as a function of temperature, etc. such as described in U.S. patent application Ser. No. 18/619,539 titled ‘FAT FORMULATIONS’ filed 28 Mar. 2024, U.S. patent application Ser. No. 18/428,575 titled ‘MILKFAT OR BUTTERFAT FORMULATIONS’ filed 31 Jan. 2024, or U.S. patent application Ser. No. 18/818,047 titled ‘LIQUID OR SEMI-SOLID FAT FORMULATIONS’ filed 28 Aug. 2024 each of which is incorporated in its entirety by this reference; while the second set of glycerides refers to a set or subset glycerides formed from fatty acids remaining in the initial distribution after removing fatty acids to form the second set of glycerides). However, the ratio can have greater than 10:1 or less than 1:10 first set of glycerides to the second set of glycerides. For instance, some formulations can include a primary set (that can optionally be divided into subsets that esterified together but separate from the other subsets) of fatty acids or glycerides derived therefrom that can account for 90-99.995% by mass (e.g., 95%, 97.5%, 99%, 99.5%, 99.75%, 99.9%, 99.95%, 99.99%, etc. of the lipid composition of the formulation and a secondary set of fatty acids or glycerides thereof that can account for the remainder of the formulation such as to achieve target properties. Variations of this specific example can provide a technical advantage of leveraging long chain fatty acids that may be present in small quantities in the as-synthesized distribution (e.g., C18-C24 fatty acids) in a secondary set (e.g., the smaller mass fraction set) to modify (improve or hinder) crystallizing or melting behaviour of the primary set (e.g., the larger mass fraction set) with minimal perturbation to other properties of the primary set (which would be more impacted if fatty acids of the secondary set were esterified with the fatty acids in the primary set).

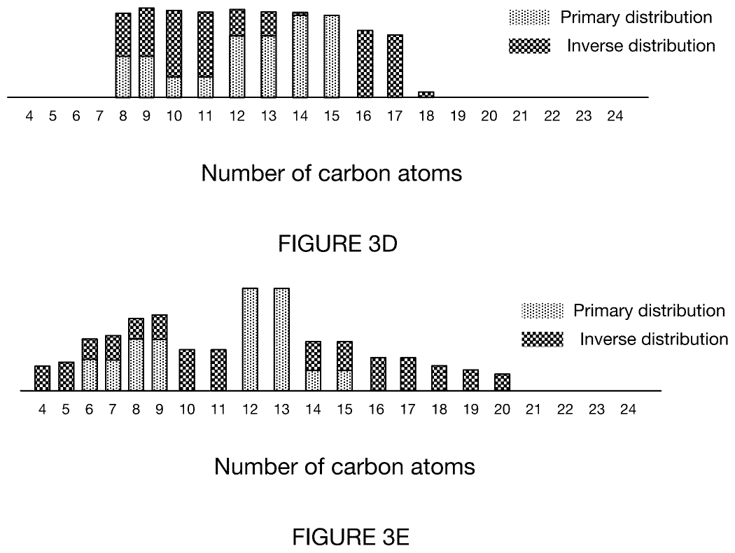

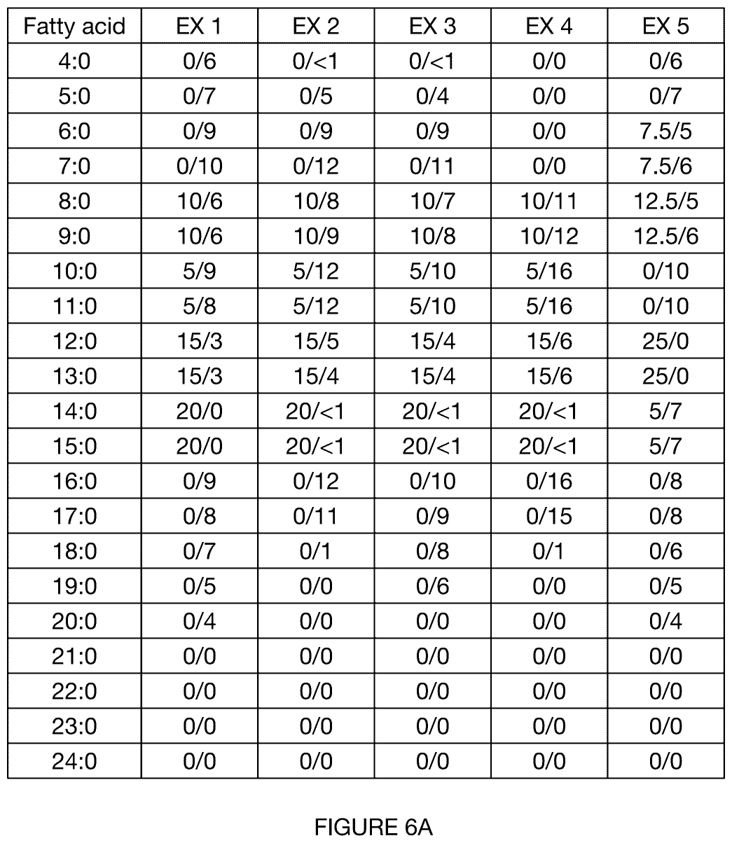

In some variants (as shown for instance in FIG. 3A, 3D, 3E, or FIG. 5), the second set of glycerides (and/or other higher numbered sets of glycerides) can include fatty acids that form the inverse distribution of fatty acids of the first set of glycerides relative to the initial distribution of fatty acids (e.g., the sum of the distribution of fatty acids of the first set of glycerides and the distribution of fatty acids of the second set of glycerides preferably results in approximately the initial fatty acid distribution, a linear combination of the distribution of fatty acids of the first set of glycerides and the distribution of fatty acids of the second set of glycerides preferably results in approximately the initial fatty acid distribution, etc.). In some variations of these variants (as shown for instance in FIG. 3B or FIG. 3C), the inverse distribution of fatty acids can be truncated to substantially exclude (e.g., include less than about 5% of) fatty acids with chain lengths greater than and/or less than a threshold chain length.

In some variants, the phase diagram between the sets of glycerides is anticipated to have a miscibility gap (e.g., where the first and second sets of glycerides exist as two or more separate phases, undergo spinodal decomposition, etc.), which can be beneficial for conferring properties from the sets of glycerides rather than resulting in new properties by combining the sets. However, the phase diagram between the sets of glycerides need not have a miscibility gap.

Typically, the distributions of fatty acids in the sets of glycerides include gaps (e.g., the fatty acid distribution used to form the sets of glycerides can be a gapped formulation such as described in U.S. patent application Ser. No. 18/210,226 titled ‘FAT FORMULATIONS’ filed 15 Jun. 2023 which is incorporated in its entirety by this reference). The inclusion of a gap (e.g., absence of two or more fatty acids with consecutive chain lengths) can provide a technical advantage of enabling complex behaviour within the set of glycerides and/or the formulation. As at least one fatty acid from the first set of glycerides is typically limited within the initial distribution, the second set of glycerides is also typically gapped (e.g., because essentially all of at least one fatty acid from the initial distribution is used in the first set). However, the sets of glycerides do not have to be gapped (e.g., can have a distribution of fatty acids used to form the glycerides such as described in U.S. patent application Ser. No. 18/428,575 titled ‘MILKFAT OR BUTTERFAT FORMULATIONS’ filed 31 Jan. 2024 or U.S. patent application Ser. No. 18/818,047 titled ‘LIQUID OR SEMI-SOLID FAT FORMULATIONS’ filed 28 Aug. 2024 each of which are incorporated in their entirety by this reference; the fatty acid distributions can be deliberately designed to not fully utilize the initial distribution such that a gap is not formed in any of the fatty acid distributions; etc.).

A gap preferably refers to one or more missing (e.g., formulation contains 0%, formulation contains less than about 5% of, etc.) even and/or even and odd pair (where even and odd pair generally refers to an even fatty acid and a fatty acid with one more carbon atom than the even fatty acid; refers to fatty acids with similar melting points such as differing by less than 10° C.; etc.) of fatty acids from the formulation. Typically, variants that include a gap will leverage a large gap (e.g., at least four missing fatty acids within the gap, at least 6 missing fatty acids within the gap, etc.) to achieve preferred properties (particularly melting point and/or viscosity but additionally or alternatively other suitable properties). However, formulations with smaller gaps can achieve the target properties. As an illustrative example, a formulation that includes fatty acids with C10:0 (e.g., capric acid) and C14:0 (e.g., myristic acid) fatty acids would be a gapped formulation as C12:0 (e.g., lauric acid) and C13:0 (e.g., tridecylic acid) are not in the formulation. As a second illustrative example, a formulation that includes fatty acid C10:0 and C12:0 fatty acids would generally not be referred to as a gapped formulation (but rather as an even-only formulation).

A formulation can include a single gap (e.g., be missing a single even carbon or even and odd pair carbon chain) and/or can include a plurality of gaps (e.g., 2 gaps, 3 gaps, 4 gaps, etc.). Similarly, in some variants, one (or more) set of glycerides used in the fat formulation can be a large gap formulation (e.g., a gap size greater than about 4 carbon atoms). As an illustrative example, a large gap set of glycerides could include C10:0, C11:0, C16:0 and C17:0 (and potentially other fatty acids with less than 10 carbon atoms or greater than 17 carbon atoms but not 12-15 carbon atoms).

In some variants, rather than a gapped formulation, a formulation can be a nonmonotonically decreasing formulation (e.g., include a nonmonotonically decreasing distribution of fatty acids from short-chain fatty acids to long-chain fatty acids or analogously a non-monotonically increasing distribution of fatty acids from long-chain fatty acids to short-chain fatty acids). In the limit that a local minimum fatty acid chain is not present could result in a gapped formulation. The inclusion of a nonmonotonically decreasing distribution can be beneficial for achieving complex behaviour (e.g., thermal behaviour, rheological properties, etc.) in the fat composition. Additionally, or alternatively, the nonmonotonically decreasing distribution can be beneficial for utilization of fatty acids derived from an as-synthesized distribution and/or can provide any suitable technical advantage.

In some variants of a gapless formulation, the formulation can monotonically decrease (and/or stay constant) from a short carbon chain fatty acid to a long carbon chain fatty acid. Examples of such distribution could include constant distribution (e.g., square distribution), triangle distribution, exponential distributions, and/or other suitable distribution. In other variants of a gapless formulation, the formulation can have other suitable structure (e.g., gaussian distribution, skewed gaussian distribution such as with a greater proportion of short chain fatty acids, polymodal distribution, etc.). Additionally or alternatively, gapped formulation can have similar bounding distributions but exclude intermediate fatty acids (e.g., fatty acid pairs).

In some variants, the formulation can include only even chain length fatty acids. These variants can be beneficial as even chain length fatty acids are generally recognized as safe to consume and/or can otherwise be beneficial. In other variants, the formulation can include even and odd chain length fatty acids. These variants can be beneficial for producing less waste, requiring less processing (e.g., fewer separations, less fractionation, less refinement, etc.), and/or can otherwise be beneficial. Typically, in variants with even and odd chain length fatty acids, the even and odd pair fatty acids are in approximately the same proportion. However, the proportion of the fatty acids of a pair need not be approximately the same (e.g., a formulation could include more of the even or odd member of an even-odd fatty acid pair for instance leveraging the difference in melting point between the two). In other variants, the fat formulation could include only odd chain length fatty acids, which may be beneficial for using materials remaining from other fat formulations (e.g., using separated fatty acids from an even-only chain formulation) or for providing metabolically advantageous properties (e.g., anti-inflammatory, anticarcinogenic, antioxidant, antibiotic, non-cytotoxic immunosuppressive, glucogenic, etc.; have an inverse relationship with disease development for: atherosclerosis, prediabetes and type II diabetes, coronary heart disease, insulin sensitivity, etc.; etc.) to food products. However, the formulation can include any suitable fatty acid(s).

The set(s) of glycerides can be entirely triglycerides (e.g., triacylglycerides); can be substantially entirely triglycerides (e.g., ≥95% triacylglycerides); can include a combination of triglycerides, diglycerides, and/or monoglycerides (e.g., include 10-30% diacylglycerides and/or monoacylglycerides with the remainder as triacylglycerides); and/or can include any suitable glycerides. The hydroxyl number (e.g., the number of milligrams of potassium hydroxide required to neutralize acetic acid taken up on acetylation of one gram of a chemical substance that contains free hydroxyl groups which can be a value for approximate monoglyceride and/or diglyceride concentration of the formulation) of the formulation (and/or each set of glycerides) is preferably less than about 100 (e.g., 1, 2, 5, 10, 15, 20, 25, 30, 40, values or ranges therebetween, <1, etc.). However, any suitable hydroxyl number can be realized. The hydroxyl number of the sets of glycerides can be the same or different (e.g., when the combination achieves the target hydroxyl number). As an illustrative example, the first set of glycerides can have a hydroxyl number of 5 and the second set of glycerides can have a hydroxyl number of 30 can be combined to achieve a formulation with hydroxyl number of about 20 with a composition that includes at least 40% of the first set of glycerides.

Each set of glycerides preferably forms heteroesters (e.g., a stochastic mixture of triglycerides with chain lengths and positions in the triacylglycerides based on the mass ratio of fatty acids in the fatty acid distribution that is esterified). For instance, to form a set of heteroesters (glycerides), free fatty acids (e.g., of a distribution of free fatty acids) can be mixed with glycerol and esterified together. The fatty acids can be esterified (e.g., coesterified, interesterified, etc.) using Fischer esterification (e.g., treating the carboxylate with an alcohol in the presence of a dehydrating agent preferably in acidic conditions), base catalyzed esterification (e.g., forming a mixture of free fatty acids or fatty acid esters and glycerol in basic conditions), Steglich esterification, Mitsunobu reaction, using epoxides, using alcoholysis (e.g., converting the fatty acid to an acyl halide or acid anhydride which is reacted with an alcohol), alkylation of carboxylate anions (e.g., reacting carboxylates of the fatty acid such as generated using a base with an alkyl halide), using the Tishchenko reaction (e.g., to convert recovered aldehydes into esters), interesterifcation (e.g., between glycerides of different fatty acids, between esters of different fatty acids, etc.), and/or using any suitable methods. Additionally or alternatively, the set of heteroesters can be formed via interesterification and/or other suitable process. The esterification can be acid catalyzed, base catalyzed, uncatalyzed, and/or catalyzed in any manner.

In some variants, rather than forming a substantially stochastic distribution of glycerides, one or more potential glyceride can be removed from and/or added into the formulation (i.e., resulting in a nonstochastic distribution of glycerides). As an illustrative example, a formulation formed using 50% C8 and 50% C14 would be expected to form triglycerides in an approximate ratio of 1:3:3:1 for C8/C8/C8:C8/C8/C14:C8/C14/C14:C14/C14/C14 triglycerides. In an illustrative example of these variants, however, the approximate ratio could be skewed such as to 1:3:3:0 for C8/C8/C8:C8/C8/C14:C8/C14/C14:C14/C14/C14 triglycerides (where the heaviest potential triglycerides and/or diglycerides are typically preferably excluded from the formulation as they are likely to have the largest melting point). However, other similar nonstoichiometric distributions can be used. As a specific example, the formulation can have less than stochastically predicted amount of homoglycerides formed with carbon chains greater than about C14 (e.g., removed by filtration for instance by removing fat particles from a mostly liquid solution). However, other suitable cutoff sizes can be used and/or changes to the distribution of glycerides can result.

The optional additives can function to modify one or more properties of the formulations. The additives can be dissolved in the lipid, dissolved in the solvent, form an emulsion with the lipid, form a separate phase from the lipid, and/or can otherwise be included in the formulation. Additives are typically included at a concentration that is less than about 10% (e.g., by mass, by volume, by stoichiometry, etc. such as 0.001%, 0.005%, 0.01%, 0.05%, 0.1%, 0.5%, 1%, 5%, values or ranges therebetween, <0.001%, etc.). Exemplary properties that additives can be used to modify can include: taste, surface tension, lipid solubility, nutritional value, rheological behaviour, properties of the formulation to mimic a target fat, oxidation susceptibility, organoleptic properties, and/or any suitable properties. Typically, additives are at most about 5% (e.g., by mass, by volume, etc.) of the formulation. However, additives can be included in an amount greater than about 5%.

Exemplary additives include flavorants, antioxidants, glycerides (e.g., monoglycerides, diglycerides, etc. such as of fatty acids of the formulation), byproducts (e.g., from a fatty acid synthesis, from esterification, etc.), nutritional additives, colorants, water, and/or any suitable additives. In some variants, air (or other introduced gas) and/or solvent (e.g., water) can act as an additive (e.g., modifying a softness, texture, spreadability, etc. of the formulation).

As a first illustrative example (as shown for instance in FIG. 4), a first set of glycerides can be derived from a set of fatty acids selected such that the first set of glycerides achieves a melting profile that matches a target fat (e.g., an animal fat, milk fat, vegetable fat, etc.). In the first illustrative example, a second set of glycerides can be derived from a set of fatty acids selected from the remainder of fatty acids remaining after the first set of fatty acids are removed from an initial distribution of fatty acids (e.g., an inverse distribution of fatty acids).

As a second illustrative example, an initial distribution (as shown for instance in FIG. 2A) can include about 4% (e.g., 3-6%) butyric acid, about 5% (e.g., 3-7%) valeric acid, about 6% (e.g., 4-8%) caproic acid, about 6% (e.g., 4-8%) enanthic acid, about 7% (e.g., 5-9%) caprylic acid, about 7.5% (e.g., 5-10%) pelargonic acid, about 7.5% (e.g., 5-10%) capric acid, about 7.5% (e.g., 5-10%) undecylic acid, about 7% (e.g., 5-9%) lauric acid, about 7% (e.g., 5-9%) tridecylic acid, about 7% (e.g., 5-9%) myristic acid, about 6% (e.g., 4-8%) pentadecylic acid, about 6% (e.g., 4-8%) palmitic acid, about 6% (e.g., 4-8%) margaric acid, about 5% (e.g., 3-7%) stearic acid, about 4% (e.g., 3-6%) nonadecylic acid, about 3% (e.g., 1.5-4.5%) arachidic acid, about 0% (e.g., 0-1%) heneicosylic acid, about 0% (e.g., 0-1%) behenic acid, about 0% (e.g., 0-1%) tricosylic acid, and about 0% (e.g., 0-1%) lignoceric acid, where the total percentages add up to 100% (and percentage typically refer to mass percentage but can additionally or alternatively refer to volume percentage, stoichiometric percentage, etc.). In variations of the second illustrative example (particularly but not exclusively targeting an animal fat, dairy fat, etc. melting profile mimic), a first set of glycerides can include glycerides derived from esterification of about 10% (e.g., 7.5%-12.5%) caprylic acid, about 10% (e.g., 7.5%-12.5%) pelargonic acid, about 5% (e.g., 2.5%-7.5%) capric acid, about 5% (e.g., 2.5%-7.5%) undecylic acid, about 15% (e.g., 10%-20%) lauric acid, about 15% (e.g., 10%-20%) tridecylic acid, about 20% (e.g., 15%-25%) myristic acid, and about 20% (e.g., 15%-25%) pentadecylic acid, where the total percentages add up to 100% (and percentage typically refer to mass percentage but can additionally or alternatively refer to volume percentage, stoichiometric percentage, etc.) with glycerol. In another variation of the second illustrative example (particularly but not exclusively targeting a fat formulation that is a gel or liquid at or near room temperature such as having a solid fat content less than about 5% at or below about 30° C.), a first set of glycerides can include glycerides derived from esterification of about 7.5% caproic acid, 7.5% enanthic acid, about 12.5% (e.g., 10%-15%) caprylic acid, about 12.5% (e.g., 10%-15%) pelargonic acid, about 25% (e.g., 20%-30%) lauric acid, about 25% (e.g., 20%-30%) tridecylic acid, about 5% (e.g., 2.5%-7.5%) myristic acid, and about 5% (e.g., 2.5%-7.5%) pentadecylic acid, where the total percentages add up to 100% (and percentage typically refer to mass percentage but can additionally or alternatively refer to volume percentage, stoichiometric percentage, etc.) with glycerol. In variations of the second illustrative example (as shown for instance in FIG. 3A), a second set of glycerides can include glycerides derived from esterification of about 6% (e.g., 4%-8%) butanoic acid, about 7% (e.g., 5%-9%) pentanoic acid, about 9% (e.g., 7%-11%) hexanoic acid, about 10% (e.g., 7.5%-12.5%) heptanoic acid, about 6% (e.g., 4%-8%) octanoic acid, about 6% (e.g., 4%-8%) nonanoic acid, about 9% (e.g., 7%-11%) decanoic acid, about 8% (e.g., 6%-10%) undecanoic acid, about 3% (e.g., 0%-5%) dodecanoic acid, about 3% (e.g., 0%-5%) tridecanoic acid, about 0% (e.g., 0%-1%) tetradecanoic acid, about 0% (e.g., 0%-1%) pentadecanoic acid, about 9% (e.g., 7%-11%) hexadecenoic acid, about 8% (e.g., 6-10%) heptadecanoic acid, about 7% (e.g., 5%-9%) octadecanoic acid, about 5% (e.g., 2.5%-7.5%) nonadecanoic acid, and about 4% (e.g., 2%-6%) icosanoic acid, where the total percentages add up to 100% (and percentage typically refer to mass percentage but can additionally or alternatively refer to volume percentage, stoichiometric percentage, etc.) with glycerol. This second set of glycerides can be combined with a first set of glycerides in an approximately 7:3 ratio (e.g., to optimally utilize the initial distribution, to generate target properties, etc.). In variations of the second illustrative example (as shown for instance in FIG. 3E), a second set of glycerides can include glycerides derived from esterification of about 6% (e.g., 4%-8%) butanoic acid, about 7% (e.g., 5%-9%) pentanoic acid, about 5% (e.g., 2.5%-7.5%) hexanoic acid, about 6% (e.g., 4%-8%) heptanoic acid, about 5% (e.g., 2.5%-7.5%) octanoic acid, about 6% (e.g., 4%-8%) nonanoic acid, about 10% (e.g., 7.5%-12.5%) decanoic acid, about 10% (e.g., 7.5%-12.5%) undecanoic acid,, about 0% (e.g., 0%-1%) dodecanoic acid,, about 0% (e.g., 0%-1%) tridecanoic acid, about 7% (e.g., 5%-9%) tetradecanoic acid, about 7% (e.g., 5%-9%) pentadecanoic acid, about 8% (e.g., 6-10%) hexadecenoic acid, about 8% (e.g., 6-10%) heptadecanoic acid, about 6% (e.g., 4%-8%) octadecanoic acid, about 5% (e.g., 2.5%-7.5%) nonadecanoic acid, and about 4% (e.g., 2%-6%) icosanoic acid,, where the total percentages add up to 100% (and percentage typically refer to mass percentage but can additionally or alternatively refer to volume percentage, stoichiometric percentage, etc.) with glycerol.

As a third illustrative example, an initial distribution (as shown for instance in FIG. 2B) can include about 0.5% (e.g., 0-2.5%) butyric acid, about 3% (e.g., 1.5-4.5%) valeric acid, about 6% (e.g., 4-8%) caproic acid, about 7.5% (e.g., 5-10%) enanthic acid, about 8% (e.g., 6-10%) caprylic acid, about 9% (e.g., 7.5-11.5%) pelargonic acid, about 9% (e.g., 7.5-11.5%) capric acid, about 9% (e.g., 7.5-11.5%) undecylic acid, about 9% (e.g., 7.5-11.5%) lauric acid, about 8% (e.g., 6-10%) tridecylic acid, about 8% (e.g., 6-10%) myristic acid, about 8% (e.g., 6-10%) pentadecylic acid, about 7.5% (e.g., 5-10%) palmitic acid, about 7% (e.g., 5-9%) margaric acid, about 0.5% (e.g., 0-2.5%) stearic acid, about 0% (e.g., 0-1%) nonadecylic acid, about 0% (e.g., 0-1%) arachidic acid, about 0% (e.g., 0-1%) heneicosylic acid, about 0% (e.g., 0-1%) behenic acid, about 0% (e.g., 0-1%) tricosylic acid, and about 0% (e.g., 0-1%) lignoceric acid, where the total percentages add up to 100% (and percentage typically refer to mass percentage but can additionally or alternatively refer to volume percentage, stoichiometric percentage, etc.). In variations of the third illustrative example (particularly but not exclusively targeting an animal fat, dairy fat, etc. melting profile mimic), a first set of glycerides can include glycerides derived from esterification of about 10% (e.g., 7.5%-12.5%) caprylic acid, about 10% (e.g., 7.5%-12.5%) pelargonic acid, about 5% (e.g., 2.5%-7.5%) capric acid, about 5% (e.g., 2.5%-7.5%) undecylic acid, about 15% (e.g., 10%-20%) lauric acid, about 15% (e.g., 10%-20%) tridecylic acid, about 20% (e.g., 15%-25%) myristic acid, and about 20% (e.g., 15%-25%) pentadecylic acid, where the total percentages add up to 100% (and percentage typically refer to mass percentage but can additionally or alternatively refer to volume percentage, stoichiometric percentage, etc.) with glycerol. In another variation of the second illustrative example (particularly but not exclusively targeting a fat formulation that is a gel or liquid at or near room temperature such as having a solid fat content less than about 5% at or below about 30° C.), a first set of glycerides can include glycerides derived from esterification of about 7.5% caproic acid, 7.5% enanthic acid, about 12.5% (e.g., 10%-15%) caprylic acid, about 12.5% (e.g., 10%-15%) pelargonic acid, about 25% (e.g., 20%-30%) lauric acid, about 25% (e.g., 20%-30%) tridecylic acid, about 5% (e.g., 2.5%-7.5%) myristic acid, and about 5% (e.g., 2.5%-7.5%) pentadecylic acid, where the total percentages add up to 100% (and percentage typically refer to mass percentage but can additionally or alternatively refer to volume percentage, stoichiometric percentage, etc.) with glycerol. In variations of the third illustrative example (as shown for instance in FIG. 3B), a second set of glycerides can include glycerides derived from esterification of about 0.5% (e.g., 0%-2%) butanoic acid, about 4.5% (e.g., 3%-6%) pentanoic acid, about 9% (e.g., 7%-11%) hexanoic acid, about 12% (e.g., 10%-15%) heptanoic acid, about 7.5% (e.g., 5%-10%) octanoic acid, about 9% (e.g., 7%-11%) nonanoic acid, about 12% (e.g., 10%-15%) decanoic acid, about 12% (e.g., 10%-15%) undecanoic acid, about 5% (e.g., 3%-7%) dodecanoic acid, about 4% (e.g., 2%-6%) tridecanoic acid, about 0.5% (e.g., 0%-2%) tetradecanoic acid, about 0% (e.g., 0%-1%) pentadecanoic acid, about 12% (e.g., 10%-15%) hexadecenoic acid, about 11% (e.g., 9%-13%) heptadecanoic acid, about 1% (e.g., 0%-2.5%) octadecanoic acid, about 0% (e.g., 0%-1%) nonadecanoic acid, and about 0% (e.g., 0%-1%) icosanoic acid, where the total percentages add up to 100% (and percentage typically refer to mass percentage but can additionally or alternatively refer to volume percentage, stoichiometric percentage, etc.) with glycerol. In variations of the third illustrative example (as shown for instance in FIG. 3C), a second set of glycerides can include glycerides derived from esterification of about 0.5% (e.g., 0%-2%) butanoic acid, about 4.5% (e.g., 3%-6%) pentanoic acid, about 9% (e.g., 7%-11%) hexanoic acid, about 11% (e.g., 9%-13%) heptanoic acid, about 7% (e.g., 5%-9%) octanoic acid, about 7.5% (e.g., 5%-10%) nonanoic acid, about 10% (e.g., 7.5%-12.5%) decanoic acid, about 10% (e.g., 7.5%-12.5%) undecanoic acid, about 4% (e.g., 2%-6%) dodecanoic acid, about 4% (e.g., 2%-6%) tridecanoic acid, about 0.5% (e.g., 0%-2%) tetradecanoic acid, about 0% (e.g., 0%-1%) pentadecanoic acid, about 10% (e.g., 7.5%-12.5%) hexadecenoic acid, about 9% (e.g., 7%-11%) heptadecanoic acid, about 7.5% (e.g., 5%-10%) octadecanoic acid, about 6% (e.g., 4%-8%) nonadecanoic acid, and about 0% (e.g., 0%-1%) icosanoic acid, where the total percentages add up to 100% (and percentage typically refer to mass percentage but can additionally or alternatively refer to volume percentage, stoichiometric percentage, etc.) with glycerol.

In variations of the third illustrative example (as shown for instance in FIG. 3D), a second set of glycerides can include glycerides derived from esterification of about 0% (e.g., 0%-1%) butanoic acid, about 0% (e.g., 0%-1%) pentanoic acid, about 0% (e.g., 0%-1%) hexanoic acid, about 0% (e.g., 0%-1%) heptanoic acid, about 10.5% (e.g., 8%-13%) octanoic acid, about 12% (e.g., 10%-14%) nonanoic acid, about 16% (e.g., 12%-20%) decanoic acid, about 16% (e.g., 12%-20%) undecanoic acid, about 6% (e.g., 4%-8%) dodecanoic acid, about 6% (e.g., 4%-8%) tridecanoic acid, about 0.5% (e.g., 0%-2%) tetradecanoic acid, about 0% (e.g., 0%-1%) pentadecanoic acid, about 16% (e.g., 12%-20%) hexadecenoic acid, about 15% (e.g., 12.5%-17.5%) heptadecanoic acid, about 1% (e.g., 0%-2.5%) octadecanoic acid, about 0% (e.g., 0%-1%) nonadecanoic acid, and about 0% (e.g., 0%-1%) icosanoic acid, where the total percentages add up to 100% (and percentage typically refer to mass percentage but can additionally or alternatively refer to volume percentage, stoichiometric percentage, etc.) with glycerol.

However, any suitable formulations can be used.

### 4. Numbered Specific Examples

A numbered list of illustrative examples of the technology described herein are provided below. A person of skill in the art will recognize that the scope of the technology is not limited to and/or by these illustrative examples.

1. A method comprising: receiving a free fatty acid sample comprising a distribution of linear saturated free fatty acids with between 4 and 22 carbon atoms; separating the free fatty acid sample into: a first free fatty acid sample comprising a first distribution of linear saturated free fatty acids selected from the free fatty acid sample; and a second free fatty acid sample comprising a second distribution of linear saturated free fatty acids that is selected from the free fatty acid sample and distinct from the first distribution of linear saturated free fatty acids (where the free fatty acid samples can be formed by fractioning the fatty acids into cuts of one or two fatty acids such as using distillation, crystallization, solvent extraction, evaporation, winterization, fractional distillation, fatty acid esterification fractionation, chromatography, centrifugation, in a manner as described in U.S. patent application Ser. No. 18/807,247 titled ‘SYSTEM AND METHOD FOR TRIGLYCERIDE MANUFACTURE’ filed 16 Aug. 2024 which is incorporated in its entirety by this reference, etc. and combining the resulting cuts into the target distribution of free fatty acids); esterifying the first free fatty acid sample with glycerol to form a first triglyceride sample; esterifying the second free fatty acid sample with glycerol to form a second triglyceride sample; and combining the first triglyceride sample and the second triglyceride sample to form a fat formulation.

2. The method of illustrative example 1, wherein a combination of the first free fatty acid sample and the second free fatty acid sample comprises at least 70% by mass of the received free fatty acid sample.

3. The method of illustrative example 1 or 2, wherein the free fatty acid sample is manufactured by oxidizing a paraffin sample and separating monocarboxylic acids from residual paraffins and other oxygenate species.

4. The method of any of illustrative examples 1-3, wherein at least one of the first distribution of linear saturated free fatty acids or the second distribution of linear saturated free fatty acids is a gapped distribution.

5. The method of any of illustrative examples 1-4, wherein separating the free fatty acid sample further comprises separating the free fatty acid sample into a third free fatty acid sample comprising a third distribution of linear saturated free fatty acids that is selected from the free fatty acid sample and is distinct from the first distribution of linear saturated free fatty acids and the second distribution of linear saturated free fatty acids.

6. The method of illustrative example 5, further comprising esterifying the third free fatty acid sample with glycerol to form a third triglyceride sample, wherein the fat formulation further comprises the third triglyceride sample.

7. The method of any of illustrative examples 1-6, wherein the distribution of linear saturated free fatty acids comprises even and odd carbon chain length fatty acids.

8. The method of illustrative example 7, wherein the first distribution of linear saturated free fatty acids and the second distribution of linear saturated free fatty acids each comprise even and odd carbon chain length fatty acids.

9. The fat formulation as produced according to any of the methods of any of illustrative examples 1-8.

10. A fat formulation comprising: a first set of triglycerides wherein each fatty acid of each triglyceride of the first set is selected from a first distribution of saturated fatty acids with between 4 and 22 carbon atoms; and a second set of triglycerides wherein each fatty acid of each triglyceride of the second set is selected from a second distribution of saturated fatty acids with between 4 and 22 carbon atoms wherein the second distribution of saturated fatty acids is different from the first distribution of fatty acids.

11. The fat formulation of illustrative example 10, wherein at least one of the first distribution of saturated fatty acids or the second distribution of saturated fatty acids comprises a gap in the respective distribution.

12. The fat formulation of either illustrative example 10 or 11, wherein at least one of the first distribution of saturated fatty acids or the second distribution of saturated fatty acids comprises even carbon chain lengths and odd carbon chain lengths.

13. The fat formulation of any of illustrative examples 10-12, wherein at least one of the first distribution of saturated fatty acids or the second distribution of saturated fatty acids comprises linear saturated fatty acids.

14. The fat formulation of any of illustrative examples 10-13, wherein the first distribution of saturated fatty acids and the second distribution of saturated fatty acids are both subdistributions from an as synthesized distribution of saturated fatty acids.

15. The fat formulation of illustrative example 14, wherein the first distribution of saturated fatty acids and the second distribution of saturated fatty acids utilize at least 70% by mass of the as-synthesized distribution of saturated fatty acids.

16. The fat formulation of illustrative example 14, wherein the as synthesized distribution of saturated fatty acids consists of: 0-5% by mass C4:0 fatty acid; 0-5% by mass C5:0 fatty acid; 1-7.5% by mass C6:0 fatty acid; 1-7.5% by mass C7:0 fatty acid; 3-8% by mass C8:0 fatty acid; 3-8% by mass C9:0 fatty acid; 5-10% by mass C10:0 fatty acid; 5-10% by mass C11:0 fatty acid; 5-10% by mass C12:0 fatty acid; 5-10% by mass C13:0 fatty acid; 5-10% by mass C14:0 fatty acid; 5-10% by mass C15:0 fatty acid; 5-10% by mass C16:0 fatty acid; 5-10% by mass C17:0 fatty acid; 1-7.5% by mass C18:0 fatty acid; 1-7.5% by mass C19:0 fatty acid; 0-5% by mass C20:0 fatty acid; 0-5% by mass C21:0 fatty acid; and 0-5% by mass C22:0 fatty acid, wherein the total percentage adds up to 100%.

17. The fat formulation of any of illustrative examples 10-16, wherein the first distribution of saturated fatty acids consists of: between 0-2.5% by mass C4:0 fatty acid; between 0-2.5% by mass C5:0 fatty acid; between 0-10% by mass C6:0 fatty acid; between 0-10% by mass C7:0 fatty acid; between 5-20% by mass C8:0 fatty acid; between 0-20% by mass C9:0 fatty acid; between 0-30% by mass C10:0 fatty acid; between 0-30% by mass C11:0 fatty acid; between 0-40% by mass C12:0 fatty acid; between 0-40% by mass C13:0 fatty acid; between 0-65% by mass C14:0 fatty acid; between 0-65% by mass C15:0 fatty acid; between 0-40% by mass C16:0 fatty acid; between 0-40% by mass C17:0 fatty acid; between 0-2.5% by mass C18:0 fatty acid; between 0-2.5% by mass C19:0 fatty acid; between 0-2.5% by mass C20:0 fatty acid; between 0-2.5% by mass C21:0 fatty acid; and between 0-2.5% by mass C22:0 fatty acid; wherein the total percentage adds up to 100%.

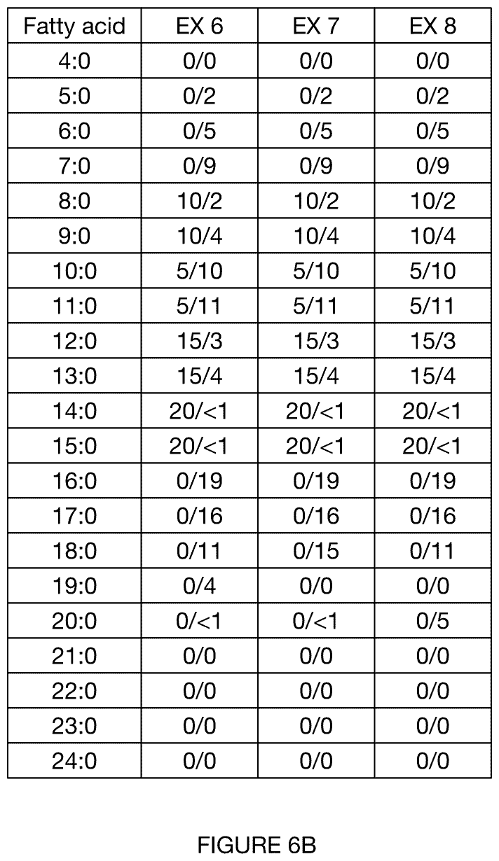

18. The fat formulation of illustrative example 17, wherein the second distribution of saturated fatty acids consists of: between 0-2.5% by mass C4:0 fatty acid; between 0-2.5% by mass C5:0 fatty acid; between 2.5-10% by mass C6:0 fatty acid; between 2.5-10% by mass C7:0 fatty acid; between 0-5% by mass C8:0 fatty acid; between 0-5% by mass C9:0 fatty acid; between 7.5-20% by mass C10:0 fatty acid; between 7.5-20% by mass C11:0 fatty acid; between 0-5% by mass C12:0 fatty acid; between 0-5% by mass C13:0 fatty acid; between 0-2.5% by mass C14:0 fatty acid; between 0-2.5% by mass C15:0 fatty acid; between 10-25% by mass C16:0 fatty acid; between 10-25% by mass C17:0 fatty acid; between 2.5-20% by mass C18:0 fatty acid; between 0-5% by mass C19:0 fatty acid; between 0-5% by mass C20:0 fatty acid; between 0-2.5% by mass C21:0 fatty acid; and between 0-2.5% by mass C22:0 fatty acid; wherein the total percentage adds up to 100% (as shown for instance in FIG. 6A or FIG. 6B).

19. The fat formulation of any of illustrative examples 10-18, further comprising a third set of triglycerides wherein each fatty acid of each triglyceride of the third set is selected from a third distribution of saturated fatty acids with between 4 and 22 carbon atoms wherein the third distribution of saturated fatty acids is different from the first and the second distributions of fatty acids.

20. The fat formulation of any of illustrative examples 10-19, wherein the first set of triglycerides comprises a hydroxyl value between 0 and 100.

21. A method for producing the fat formulation of any of illustrative examples 10-20.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. A method comprising:
receiving a free fatty acid sample comprising a distribution of linear saturated free fatty acids with between 4 and 22 carbon atoms;
separating the free fatty acid sample into:
a first free fatty acid sample comprising a first distribution of linear saturated free fatty acids selected from the free fatty acid sample; and
a second free fatty acid sample comprising a second distribution of linear saturated free fatty acids that is selected from the free fatty acid sample and distinct from the first distribution of linear saturated free fatty acids;
esterifying the first free fatty acid sample with glycerol to form a first triglyceride sample;
esterifying the second free fatty acid sample with glycerol to form a second triglyceride sample; and
combining the first triglyceride sample and the second triglyceride sample to form a fat formulation.

2. The method of claim 1, wherein a combination of the first free fatty acid sample and the second free fatty acid sample comprises at least 70% by mass of the received free fatty acid sample.

3. The method of claim 1, wherein the free fatty acid sample is manufactured by oxidizing a paraffin sample and separating monocarboxylic acids from residual paraffins and other oxygenate species.

4. The method of claim 1, wherein at least one of the first distribution of linear saturated free fatty acids or the second distribution of linear saturated free fatty acids is a gapped distribution.

5. The method of claim 1, wherein separating the free fatty acid sample further comprises separating the free fatty acid sample into a third free fatty acid sample comprising a third distribution of linear saturated free fatty acids that is selected from the free fatty acid sample and is distinct from the first distribution of linear saturated free fatty acids and the second distribution of linear saturated free fatty acids.

6. The method of claim 5, further comprising esterifying the third free fatty acid sample with glycerol to form a third triglyceride sample, wherein the fat formulation further comprises the third triglyceride sample.

7. The method of claim 1, wherein the distribution of linear saturated free fatty acids comprises even and odd carbon chain length fatty acids.

8. The method of claim 7, wherein the first distribution of linear saturated free fatty acids and the second distribution of linear saturated free fatty acids each comprise even and odd carbon chain length fatty acids.

9. The fat formulation as produced according to the method of claim 1.

10. A fat formulation comprising:
a first set of triglycerides wherein each fatty acid of each triglyceride of the first set is selected from a first distribution of saturated fatty acids with between 4 and 22 carbon atoms; and
a second set of triglycerides wherein each fatty acid of each triglyceride of the second set is selected from a second distribution of saturated fatty acids with between 4 and 22 carbon atoms wherein the second distribution of saturated fatty acids is different from the first distribution of fatty acids.

11. The fat formulation of claim 10, wherein at least one of the first distribution of saturated fatty acids or the second distribution of saturated fatty acids comprises a gap in the respective distribution.

12. The fat formulation of claim 10, wherein at least one of the first distribution of saturated fatty acids or the second distribution of saturated fatty acids comprises even carbon chain lengths and odd carbon chain lengths.

13. The fat formulation of claim 10, wherein at least one of the first distribution of saturated fatty acids or the second distribution of saturated fatty acids comprises linear saturated fatty acids.

14. The fat formulation of claim 10, wherein the first distribution of saturated fatty acids and the second distribution of saturated fatty acids are both subdistributions from an as-synthesized distribution of saturated fatty acids.

15. The fat formulation of claim 14, wherein the first distribution of saturated fatty acids and the second distribution of saturated fatty acids utilize at least 70% by mass of the as-synthesized distribution of saturated fatty acids.

16. The fat formulation of claim 14, wherein the as synthesized distribution of saturated fatty acids consists of:
0-5% by mass C4:0 fatty acid;
0-5% by mass C5:0 fatty acid;
1-7.5% by mass C6:0 fatty acid;
1-7.5% by mass C7:0 fatty acid;
3-8% by mass C8:0 fatty acid;
3-8% by mass C9:0 fatty acid;
5-10% by mass C10:0 fatty acid;
5-10% by mass C11:0 fatty acid;
5-10% by mass C12:0 fatty acid;
5-10% by mass C13:0 fatty acid;
5-10% by mass C14:0 fatty acid;
5-10% by mass C15:0 fatty acid;
5-10% by mass C16:0 fatty acid;
5-10% by mass C17:0 fatty acid;
1-7.5% by mass C18:0 fatty acid;
1-7.5% by mass C19:0 fatty acid;
0-5% by mass C20:0 fatty acid;
0-5% by mass C21:0 fatty acid; and
0-5% by mass C22:0 fatty acid,
wherein the total percentage adds up to 100%.

17. The fat formulation of claim 10, wherein the first distribution of saturated fatty acids consists of:
between 0-2.5% by mass C4:0 fatty acid;
between 0-2.5% by mass C5:0 fatty acid;
between 0-10% by mass C6:0 fatty acid;
between 0-10% by mass C7:0 fatty acid;
between 5-20% by mass C8:0 fatty acid;
between 0-20% by mass C9:0 fatty acid;
between 0-30% by mass C10:0 fatty acid;
between 0-30% by mass C11:0 fatty acid;
between 0-40% by mass C12:0 fatty acid;
between 0-40% by mass C13:0 fatty acid;
between 0-65% by mass C14:0 fatty acid;
between 0-65% by mass C15:0 fatty acid;
between 0-40% by mass C16:0 fatty acid;
between 0-40% by mass C17:0 fatty acid;
between 0-2.5% by mass C18:0 fatty acid;
between 0-2.5% by mass C19:0 fatty acid;
between 0-2.5% by mass C20:0 fatty acid;
between 0-2.5% by mass C21:0 fatty acid; and
between 0-2.5% by mass C22:0 fatty acid;
wherein the total percentage adds up to 100%.

18. The fat formulation of claim 17, wherein the second distribution of saturated fatty acids consists of:
between 0-2.5% by mass C4:0 fatty acid;
between 0-2.5% by mass C5:0 fatty acid;
between 2.5-10% by mass C6:0 fatty acid;
between 2.5-10% by mass C7:0 fatty acid;
between 0-5% by mass C8:0 fatty acid;
between 0-5% by mass C9:0 fatty acid;
between 7.5-20% by mass C10:0 fatty acid;
between 7.5-20% by mass C11:0 fatty acid;
between 0-5% by mass C12:0 fatty acid;
between 0-5% by mass C13:0 fatty acid;
between 0-2.5% by mass C14:0 fatty acid;
between 0-2.5% by mass C15:0 fatty acid;
between 10-25% by mass C16:0 fatty acid;
between 10-25% by mass C17:0 fatty acid;
between 2.5-20% by mass C18:0 fatty acid;
between 0-5% by mass C19:0 fatty acid;
between 0-5% by mass C20:0 fatty acid;
between 0-2.5% by mass C21:0 fatty acid; and
between 0-2.5% by mass C22:0 fatty acid;
wherein the total percentage adds up to 100%.

19. The fat formulation of claim 10, further comprising a third set of triglycerides wherein each fatty acid of each triglyceride of the third set is selected from a third distribution of saturated fatty acids with between 4 and 22 carbon atoms wherein the third distribution of saturated fatty acids is different from the first and the second distributions of fatty acids.

20. The fat formulation of claim 10, wherein the first set of triglycerides comprises a hydroxyl value between 0 and 100.
